(19) United States
(12) Patent Application Publication
(10) Pub. No.: US 2009/0300476 A1
(43) Pub. Date: Dec. 3, 2009

(54) Internet Guide Link Matching System

(76) Inventors: Robert B. Vogel, Delray Beach, FL (US); Robert Yerby, Davie, FL (US)

Correspondence Address: FOLEY & LARDNER LLP, 150 EAST GILMAN STREET, P.O. BOX 1497, MADISON, WI, 53701-1497, US

(21) Appl. No.: 12/280,495

(22) PCT Filed: Nov. 8, 2006
(86) PCT No.: PCT/US2006/043725

§ 371 Date: May 21, 2009

Related U.S. Application Data
(60) Provisional application No. 60/776,749, filed on Feb. 24, 2006.

(51) Int. Cl. G06F 17/30; G06F 17/00; G06Q 30/00; G06F 3/16; G06F 3/048

(52) U.S. Cl. 715/234; 707/5; 705/26; 715/727; 715/808; 707/E17.017

(57) ABSTRACT

A method of identifying relevant information while a user views an application user interface is provided. A keyword(s) is identified from an application user interface presented at a first computer, wherein the identification is performed transparent to a user viewing the application user interface. The identified keyword is compared with information associated with a plurality of guide links. A guide link is associated with a categorized collection of information about a topic. A relevant guide link of the plurality of guide links is identified based on the comparison. If a relevant guide link is identified, a match between the identified keyword and the identified guide link is indicated at the first computer. If a relevant guide link is identified, a user may view the identified guide link at the first computer.

### FIELD OF THE INVENTION

The subject of the disclosure relates generally to the field of identifying relevant information in a network.

### BACKGROUND OF THE INVENTION

The Internet is a wide area network that connects hundreds of thousands of computers and smaller sub-networks world-wide. Businesses, government bodies and entities, educational organizations, and even individuals publish information or data organized in the form of websites. A website may comprise multiple web pages that display a specific set of information and may contain links to other web pages with related or additional information. Each web page is identified by a Uniform Resource Locator (URL) that includes the location or address of the computer that contains the resource to be accessed in addition to the location of the resource on that computer. The type of file or resource depends on the Internet application protocol. For example, the Hypertext Transfer Protocol (HTTP) describes a web page to be accessed with a web browser application. The file accessed may be a simple text file, an image file, an audio file, a video file, an executable, a common gateway interface application, a Java applet, or any other file supported by HTTP.

Search engines accept one or more keywords identified by a user and identify documents on a network including the Internet that contain the keywords. The search engine returns lists of hyperlinks to the documents where the keywords were found. Typically, a search engine sends out a software “spider” to fetch as many electronic documents as possible. Another program, called an “indexer,” reads these documents and creates an index of URLs based on the keywords contained in each document. Each search engine typically uses a distinct proprietary algorithm to create its indices such that meaningful results are returned for each query.

There are a number of limitations and disadvantages associated with search engines. One problem is that a general search engine is designed to provide all types of general information to all types of users. A general search engine's search algorithms are typically designed to “horizontally” search for a breadth of information to provide general types of information. This horizontal search approach causes individuals looking for specific information on the World Wide Web to look through hundreds, if not thousands, of irrelevant pieces of information to finally locate the information they seek, provided they find it at all.

Still another problem is that general search engines often return indexes including a large number of links to information that is not closely related to a search requested by a user. This makes it difficult for a user to locate desired information and often leads to user confusion and user dissatisfaction. For example, a search query for a “tiger” will return thousands of websites with information on tigers (the animal), as well as Tiger Woods (the professional golfer), and a host of other businesses operating in connection with the name “tiger”. As a result, the user may be required to sift through thousands of websites in order to find the information that best responds to the specific area of interest. Thus, there exists a need for a mechanism for use in conjunction with a computer network such as the Internet that overcomes the disadvantages present in the art.

### SUMMARY

Exemplary embodiments provide a mechanism that efficiently identifies relevant information for users. An exemplary device includes, but is not limited to, a processor. The processor is configured to identify a keyword from an application user interface, wherein the identification is performed transparent to a user viewing the application user interface; compare the identified keyword with information associated with a plurality of guide links, wherein a guide link is associated with a categorized collection of information about a topic; identify a relevant guide link of the plurality of guide links that matches the identified keyword based on the comparison; if a relevant guide link is identified, indicate a match between the identified keyword and the identified guide link; and if a relevant guide link is identified, allow a user to view the identified guide link.

An exemplary method of identifying relevant information while a user views an application user interface is provided. A keyword(s) is identified from an application user interface presented at a first computer, wherein the identification is performed transparent to a user viewing the application user interface. The identified keyword is compared with information associated with a plurality of guide links. A guide link is associated with a categorized collection of information about a topic. A relevant guide link of the plurality of guide links is identified based on the comparison. If a relevant guide link is identified, a match between the identified keyword and the identified guide link is indicated at the first computer. If a relevant guide link is identified, a user may view the identified guide link at the first computer.

Another exemplary embodiment of the invention includes computer-readable instructions that, upon execution by a processor, cause the processor to implement the operations of the method.

Other principal features and advantages of the invention will become apparent to those skilled in the art upon review of the following drawings, the detailed description, and the appended claims.

### BRIEF DESCRIPTION OF THE DRAWINGS

Exemplary embodiments of the invention will hereafter be described with reference to the accompanying drawings, wherein like numerals will denote like elements.

FIG. 1 depicts a first user interface for an information directory tree in accordance with an exemplary embodiment.

FIG. 2 depicts a second user interface for the information directory tree of FIG. 1 in accordance with an exemplary embodiment.

FIG. 3 depicts a guide link user interface in accordance with a first exemplary embodiment.

FIG. 4 depicts a guide link user interface in accordance with a second exemplary embodiment.

FIG. 5 depicts a guide link user interface in accordance with a third exemplary embodiment.

FIG. 6 depicts a third user interface for accessing a search capability using a browser application in accordance with an exemplary embodiment.

FIG. 7 depicts a fourth user interface indicating a presentation format for search results in accordance with an exemplary embodiment.

FIG. 8 depicts presentation of a matching guide link including an indication of the directory path in accordance with an exemplary embodiment.

FIG. 9 depicts a tool bar for indicating a guide link match in accordance with a first exemplary embodiment.

FIG. 10 depicts the tool bar of FIG. 9 indicating a match in accordance with an exemplary embodiment.

FIG. 11 depicts a fourth user interface including a hierarchy of informational links in accordance with an exemplary embodiment.

FIG. 12 depicts a fifth user interface including links to review and to purchase a product in accordance with an exemplary embodiment.

FIG. 13 depicts a sixth user interface including price comparison information for a type of product in accordance with an exemplary embodiment.

FIG. 14 depicts a seventh user interface including links various deals in accordance with an exemplary embodiment.

FIG. 15 depicts an eighth user interface including organized groupings of favorite links in accordance with an exemplary embodiment.

FIG. 16 is a flow diagram illustrating exemplary operations performed by a guide link match engine application in accordance with an exemplary embodiment.

FIG. 17 depicts a ninth user interface presenting matching results in accordance with a first exemplary embodiment.

FIG. 18 depicts a tenth user interface presenting matching results in accordance with a second exemplary embodiment.

FIG. 19 depicts an eleventh user interface of an application used to develop and maintain the information directory tree of FIG. 1 in accordance with an exemplary embodiment.

FIG. 20 depicts additional structural details related to a work area of the eleventh user interface of FIG. 19 in accordance with an exemplary embodiment.

FIG. 21 is a diagram of a guide link match engine system in accordance with an exemplary embodiment.

FIG. 22 is a block diagram of a match engine user's computing device in accordance with an exemplary embodiment.

FIG. 23 is a block diagram of a guide link developer's computing device in accordance with an exemplary embodiment.

FIG. 24 depicts a guide link user interface in accordance with a fourth exemplary embodiment.

### DETAILED DESCRIPTION

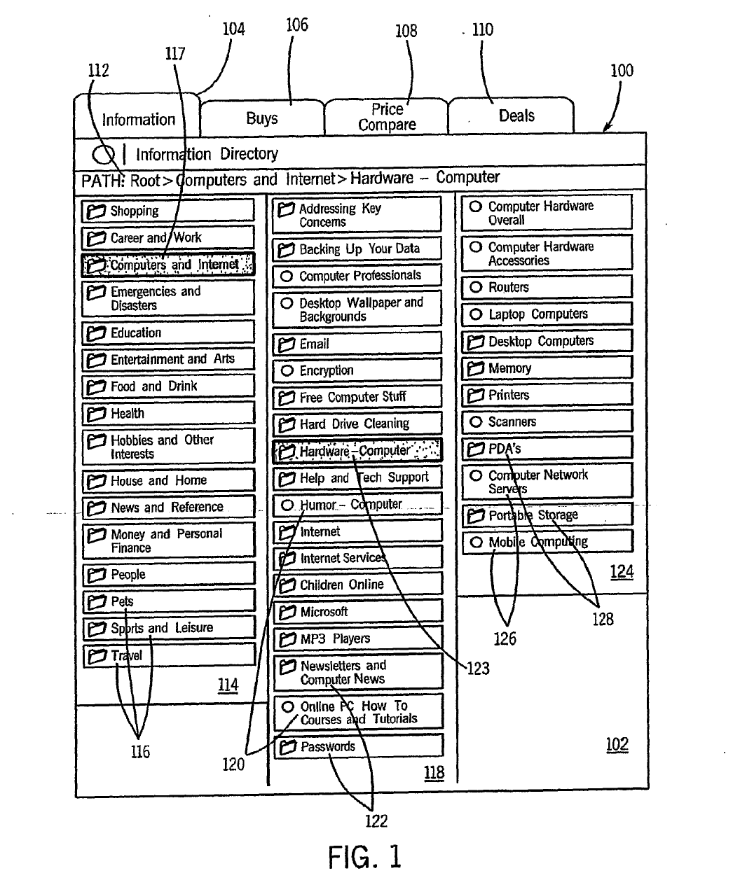

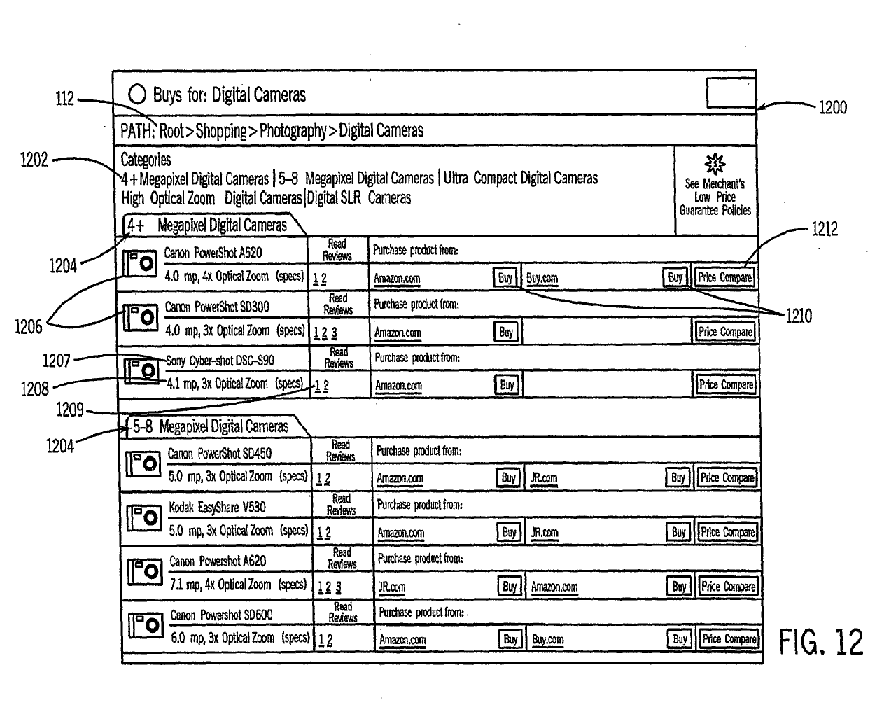

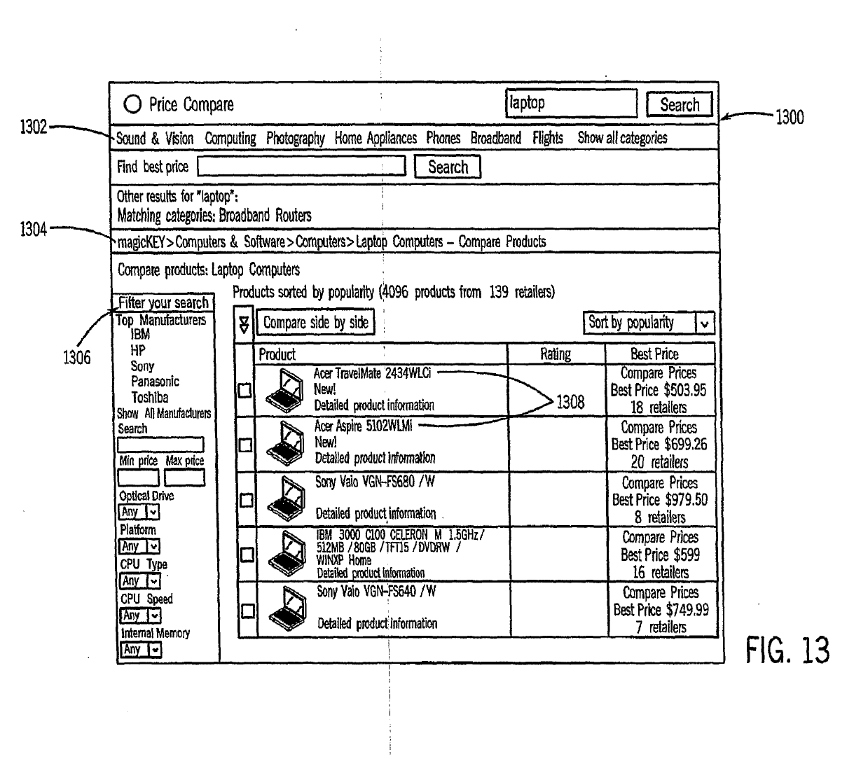

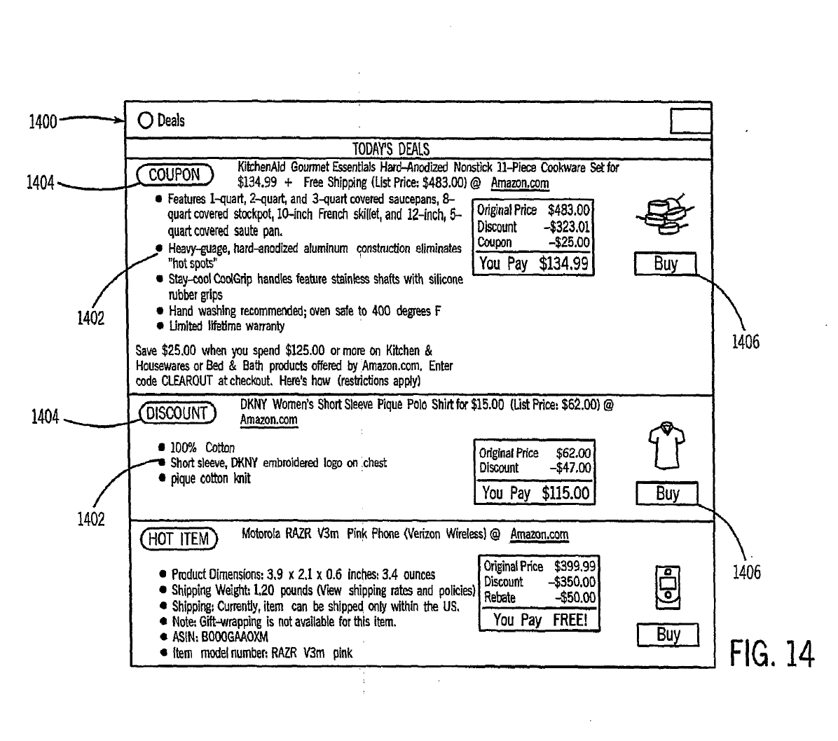

With reference to FIG. 1, a first user interface 100 includes an information directory tree 102 which provides a method for easily accessing information associated with a variety of topics. First user interface 100 may be accessed, for example, using a URL entered in a web browser address window. First user interface 100 may include an information tab 104, a purchase tab 106, a price compare tab 108, and a deals tab 110. A user may select any of information tab 104, purchase tab 106, price compare tab 108, and deals tab 110 using a user interface device such as a keyboard, mouse, or touch sensitive display. Selection of information tab 104 presents information directory tree 102 to a user in a user interface window. Selection of purchase tab 106 presents purchasing options to a user in a user interface window, for example, the user interface window described with reference to FIG. 12. Selection of price compare tab 108 presents price comparison information for a product to a user in a user interface window, for example, the user interface window described with reference to FIG. 13. Selection of deals tab 110 presents information related to deals available for various products to a user in a user interface window, for example, the user interface window described with reference to FIG. 14.

Information window 102 may include a directory path 112, a first column 114, a second column 118, and a third column 124. Directory path 112 may be dynamically developed as the user navigates within information window 102. Directory path 112 is displayed above first column 114, second column 118, and third column 124 in the exemplary embodiment of FIG. 1. First column 114, second column 118, and third column 124 represent a hierarchy of topics in information directory tree 102. First column 114 contains a set of topic folders 116. Selection of a topic folder 117 from first column 114 causes the selected topic folder 117 to be highlighted or otherwise indicate its selection by a user for more information. One or more guide links 120 and/or one or more sub-topic folders 122 of selected topic folder 117 are displayed in second column 118 just right of first column 114. Thus, the displayed one or more guide links 120 and/or one or more sub-topic folders 122 of selected topic folder 117 vary dynamically based on the selected topic folder of the set of topic folders 116 of first column 114.

A user can select any part of information directory tree 102 at any time to view additional guide links and/or folder links. The user can also select any part of directory path 112 and be redirected within information directory tree 102. Icons indicate whether the link in the column is a folder link or a guide link to enable the user to distinguish between the two types of informational entities. Folders and guide links may be distinguished using colors, icons, etc. When the user selects a guide link, a guide link interface is presented to the user. When the user selects a folder link, another column of information is presented to the user for selection of a sub-topic.

A guide link is a link to a categorized collection of information about a topic that provides users with higher quality, more relevant results about a topic and presents the results quickly and in an organized format. The information about a topic can include, but is not limited to, links to websites about the topic, custom free form content, links to tips and techniques regarding the topic, available deals, pricing, specific related products, etc. The content may be gathered and maintained using a guide link development application and/or gathered and maintained using various automated systems and processes. Links to informational websites and other content presented in a guide link user interface are selected and included in a guide link database generally using the guide link development application. In contrast to typical web results which can return millions of sites, a guide link provides a short, organized list of relevant sites. The content and links are organized into a group of standard sub-folders, allowing a user to quickly find the type of information needed.

Selection of a sub-topic folder 123 from second column 118 causes the selected sub-topic folder 123 to be highlighted or otherwise indicate its selection by a user for more information. One or more guide links 126 and/or one or more sub-topic folders 128 of selected sub-topic folder 123 are displayed in third column 124 just right of second column 118. Thus, the displayed one or more guide links 126 and/or one or more sub-topic folders 128 of third column 124 vary dynamically based on the selected sub-topic folder of the set of sub-topic folders 122 of second column 118.

Information directory tree 102 is fully dynamic, displaying the appropriate information based on which part of information directory tree 102 the user selects. The number of columns displayed may increase or decrease dynamically based on the part of information directory tree 102 the user selects. There may be one or more columns displayed at any time. If more columns are needed, the system presents the most recently selected levels near the center of the screen so that the position within information directory tree 102 remains visible at least one level up and one level down on any user interface presentation of information directory tree 102.

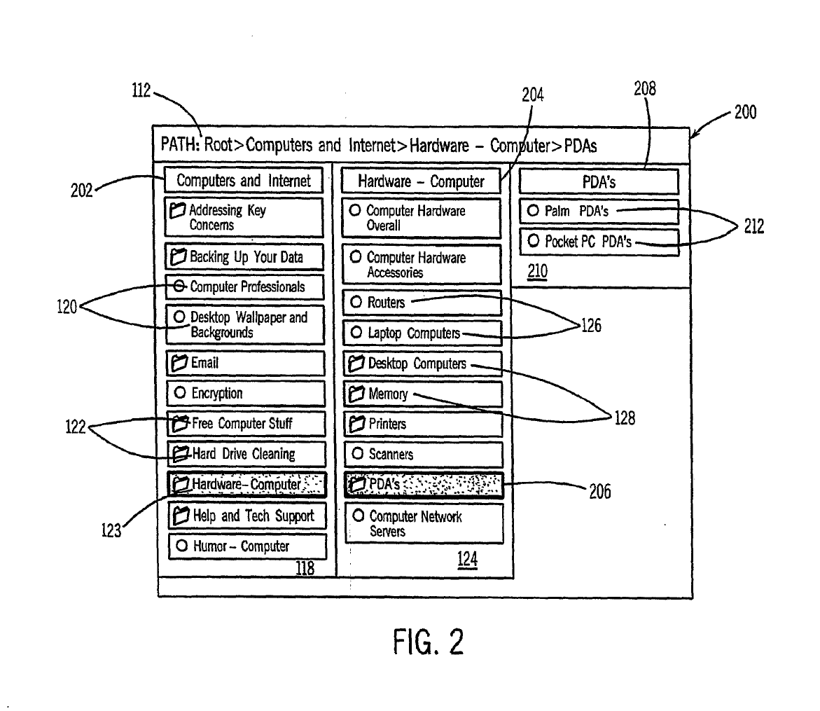

Various techniques can be used to keep the user oriented relative to their position in information directory tree 102. With reference to FIG. 2, a second user interface 200 includes additional portions of information directory tree 102. Second column 118 is presented on the far left and first column 114 is no longer shown. A first parent header 202 of second column 118 appears above second column 118 to identify the selected topic folder 117. Additionally, directory path 112 dynamically updates to indicate the hierarchy of information that the user has selected to view.

Selection of sub-topic folder 123 from second column 118 (now in the first column position) causes one or more guide links 126 and/or one or more sub-topic folders 128 of selected sub-topic folder 123 to be displayed in third column 124 (now in the second column position) just right of second column 118. A second parent header 204 of third column 124 appears above third column 124 to identify the selected sub-topic folder 123. Selection of sub-topic folder 206 from third column 124 causes presentation of a fourth column 210 just right of third column 124, which may include one or more guide links 212 associated with selected sub-topic folder 206. A third parent header 208 of fourth column 210 appears above fourth column 210 to identify the selected sub-topic folder 206. Thus, depending on selections made by the user from information directory tree 102, first user interface 100 and/or second user interface 200 may include a greater or a fewer number of columns. First user interface 100 and second user interface 200 present different levels of information directory tree 102. There is no limit to the number of levels of information directory tree 102 that can be presented.

A guide link user interface can present the guide link content in a variety of ways. Sub-folders presented within the guide link user interface follow a clear process, for example, a shopping process that includes researching and buying. Content and website links presented in a sub-folder can be displayed based on a priority or alphabetically. The data associated with a guide link can be presented using a variety of formats, including on a web page, in a toolbar, from a favorites folder, etc.

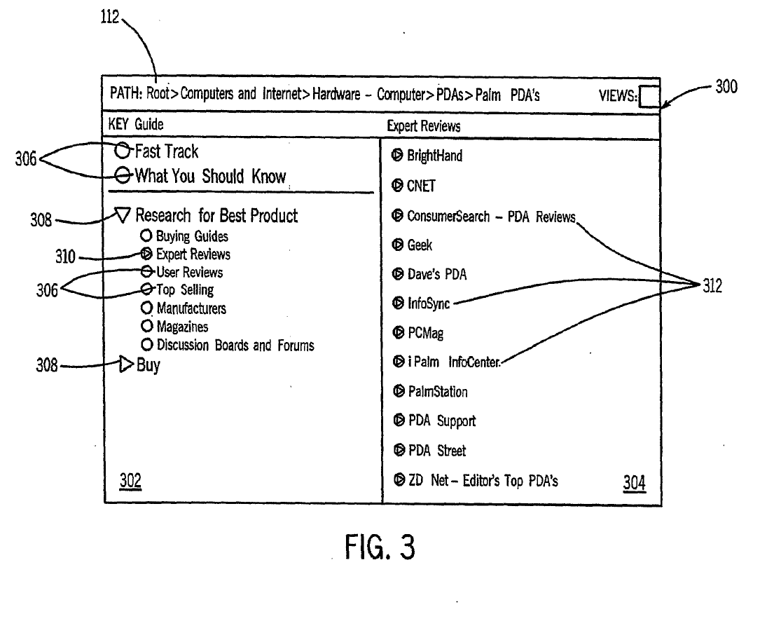

With reference to FIG. 3, a guide link user interface 300 is shown in accordance with a first exemplary embodiment. Guide link user interface 300 provides a folder view. Using the folder view, the user selects the particular folder to expand and view using a user interface device such as a keyboard, mouse, or touch sensitive display. Guide link user interface 300 may include directory path 112, a topic selection window 302, and an information link window 304. The contents of topic selection window 302 dynamically vary based on the guide link selected and its style. Topic selection window 302 may include one or more subject links 306 and one or more subject link drop down selectors 308 which may include one or more subject links 306. Information link window 304 may include one or more information links 312. Selection of a subject link 310 from the one or more subject links 306 causes the display of the one or more information links 312 in information link window 304. Thus, the displayed one or more information links 312 vary dynamically based on the selected subject link of the one or more subject links 306.

With reference to FIG. 3, the one or more subject links 306 are associated with a guide link for “Palm PDAs.” The one or more subject links 306 of guide link user interface 300 include “Fast Track” and “What You Should Know.” The one or more subject link drop down selectors 308 of guide link user interface 300 include “Research for Best Product” and “Buy.” The one or more subject links 306 of guide link user interface 300 of the subject link drop down selector “Research for Best Product” include “Buying Guides,” “Expert Reviews,” “User Reviews,” “Top Selling,” “Manufacturers,” “Magazines,” and “Discussion Boards and Forums.”

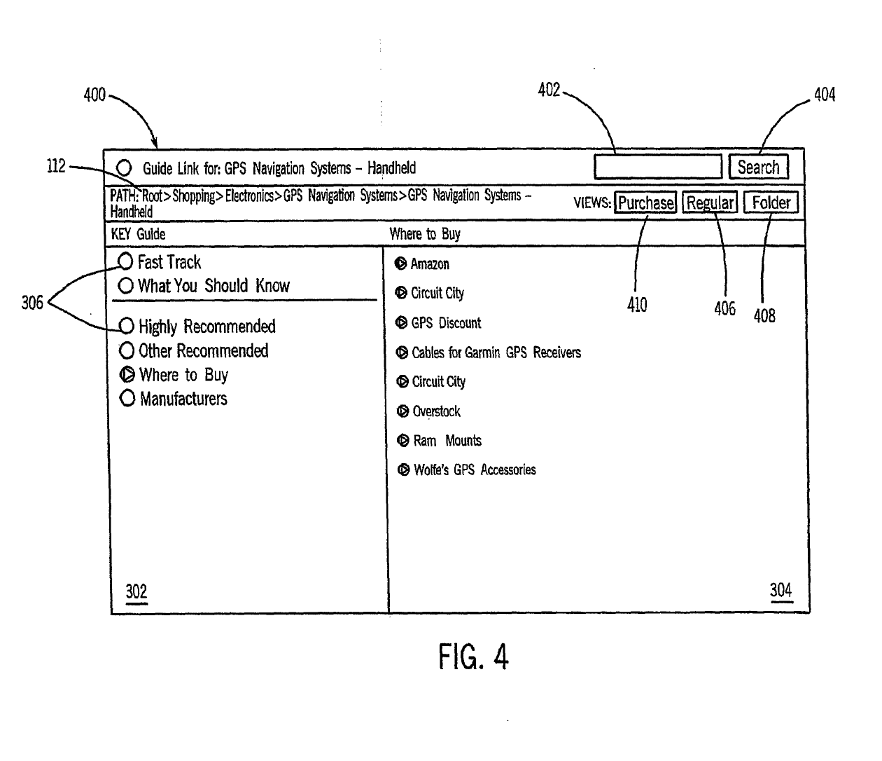

With reference to FIG. 4, a guide link user interface 400 is shown in accordance with a second exemplary embodiment. Guide link user interface 400 includes a guide link associated with “GPS Navigation Systems—Handheld.” The one or more subject links 306 of guide link user interface 400 include “Fast Track,” “What You Should Know,” “Highly Recommended,” “Other Recommended,” “Where to Buy,” and “Manufacturers.” Guide link user interface 400 further may include a search text box 402, a search button 404, a “Regular” guide link view button 406, a “Folder” guide link view button 408, and a purchase button 410. A search keyword(s) may be entered into search text box 402. Search button 404 is selected and a search is conducted matching the search keyword(s), for example, with nodes in information directory tree 102. Regular guide link view button 406 and Folder guide link view button 408 allow the user to select between different presentation formats for displaying the categorized information for a selected guide link. For example, Folder guide link view button 408 provides the presentation format illustrated in FIGS. 3 and 4. Selection of purchase button 410 presents purchasing options to a user in a user interface window, for example, the user interface window described with reference to FIG. 12.

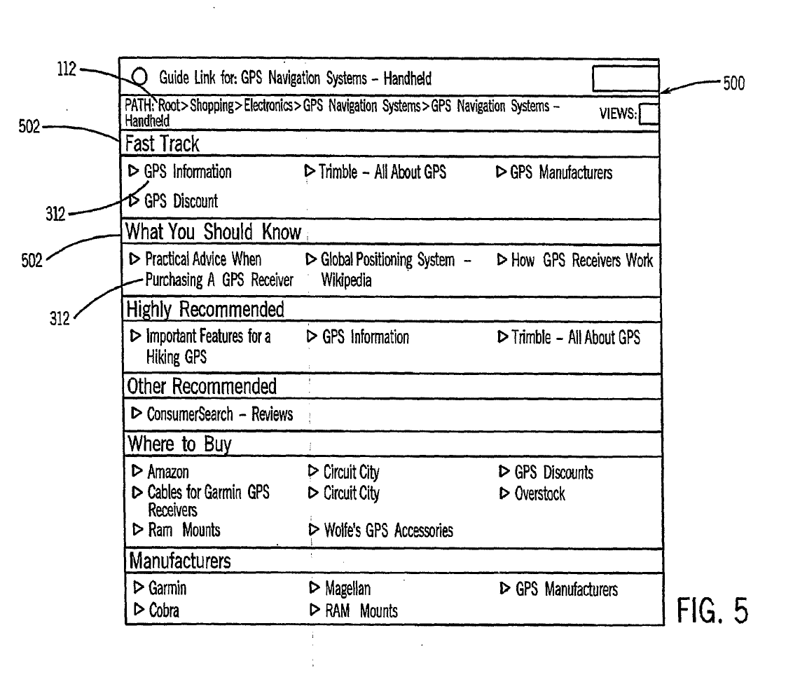

With reference to FIG. 5, a guide link user interface 500 is shown in accordance with a third exemplary embodiment which provides an expanded view of the sub-folders in accordance with selection of Regular guide link view button 406. Guide link user interface 500 provides a second view of the guide link associated with “GPS Navigation Systems—Handheld.” Guide link user interface 500 includes directory path 112 and one or more subject headers 502 with each of the one or more subject headers 502 followed by one or more information links 312. The one or more subject headers 502 of guide link user interface 500 include “Fast Track,” “What You Should Know,” “Highly Recommended,” “Other Recommended,” “Where to Buy,” and “Manufacturers.”

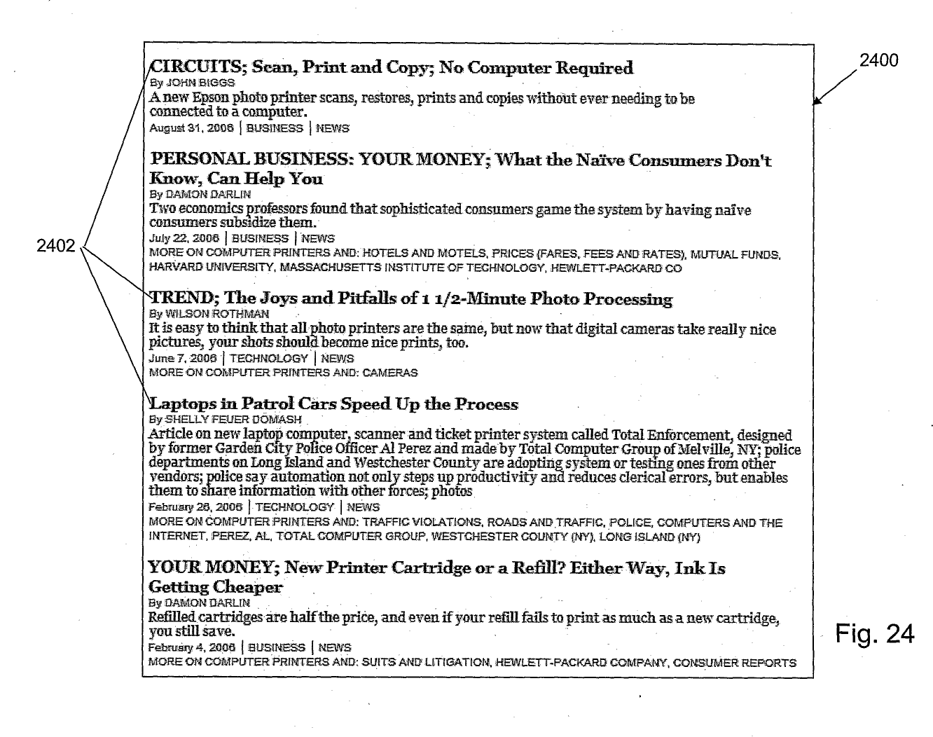

With reference to FIG. 24, a guide link user interface 2400 is shown in accordance with a fourth exemplary embodiment. Guide link user interface 2400 provides a list of articles 2402 associated with a guide link. The list of articles 2402 dynamically vary based on the guide link selected and comprise a categorized collection of information about the guide link.

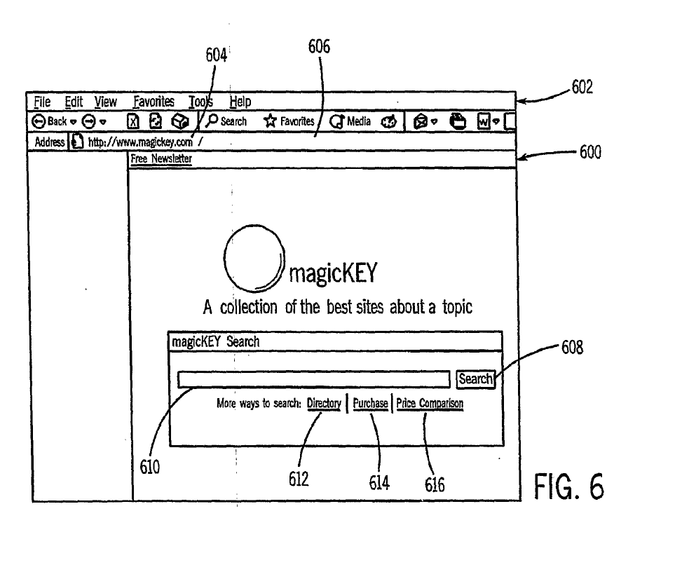

To find a desired guide link, a user may for example navigate through information directory tree 102 until finding the desired guide link. Alternatively, a user may perform a keyword search. With reference to FIG. 6, a third user interface 600 is shown in accordance with an exemplary embodiment. Third user interface 600 may be presented using a browser application 602 as known to those skilled in the art. Browser application 602 may include an address window 606 in which the user enters a URL 604. Third user interface 600 is displayed when the user enters URL 604 into address window 606 and indicates the desire to go to the entered URL 604. Third user interface 600 may include a second search button 608, a second search text box 610, a “Directory” button 612, a “Purchase” button 614, and a “Price Comparison” button 616. User selection of Directory button 612 may cause presentation of information directory tree 102, for example, as shown with respect to first user interface 100. Selection of Purchase button 614 presents purchasing options to a user in a user interface window, for example, the user interface window described with reference to FIG. 12. Selection of Price Comparison button 616 presents price comparison information for a product to a user in a user interface window, for example, the user interface window described with reference to FIG. 13.

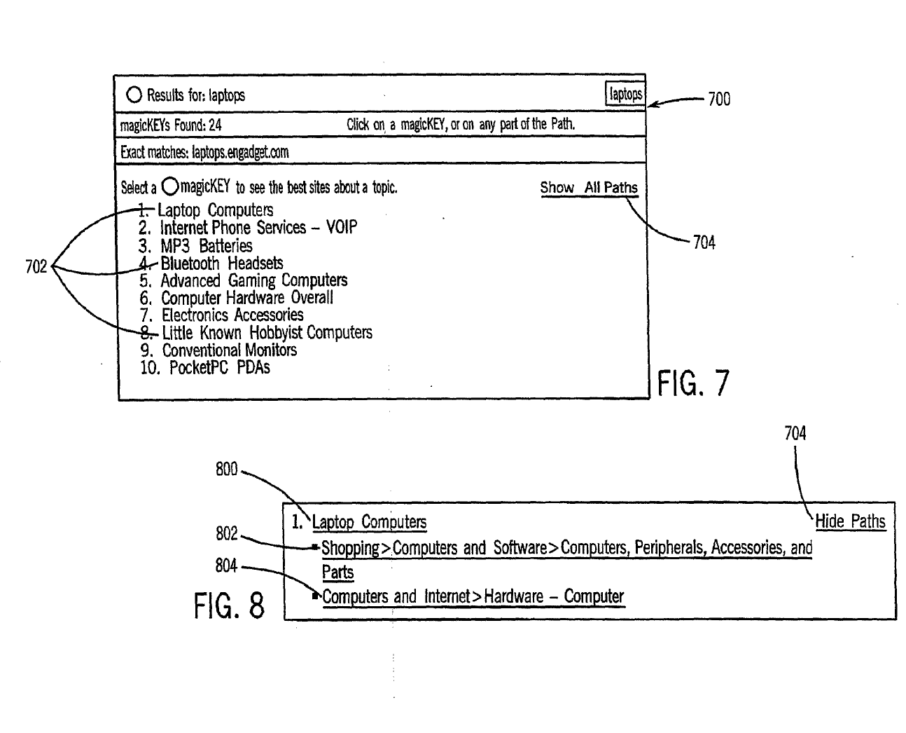

A search keyword(s) may be entered into second search text box 610. Second search button 608 is selected and a search is conducted matching the search keyword(s), for example, with nodes in information directory tree 102. For example, with reference to FIG. 7, the keyword “laptops” was entered in search text box 610 and second search button 608 was selected. In response, a first search result user interface 700 may be presented to the user. First search result user interface 700 may include one or more guide links 702 which match the keyword “laptops” and a paths option button 704. Selection of a guide link from the one or more guide links 702 causes presentation of the guide link user interface for the selected guide link.

Paths option button 704 is a switch that allows a user to turn on or off display of the directory path for the one or more guide links 702. For example, with reference to FIG. 8, paths option button 704 has been switched to display the directory path of the one or more guide links 702. The path of each guide link identified by matching the keyword with keywords associated with each guide link can be displayed to the user to provide the context of information directory tree 102 in which the guide link may be reached. The user can select any part of the displayed path to view that portion of information directory tree 102. A guide link can be in one or more paths in information directory tree 102. For example, a first path 802 and a second path 804 are defined for reaching a guide link 800 titled “Laptop Computers.”

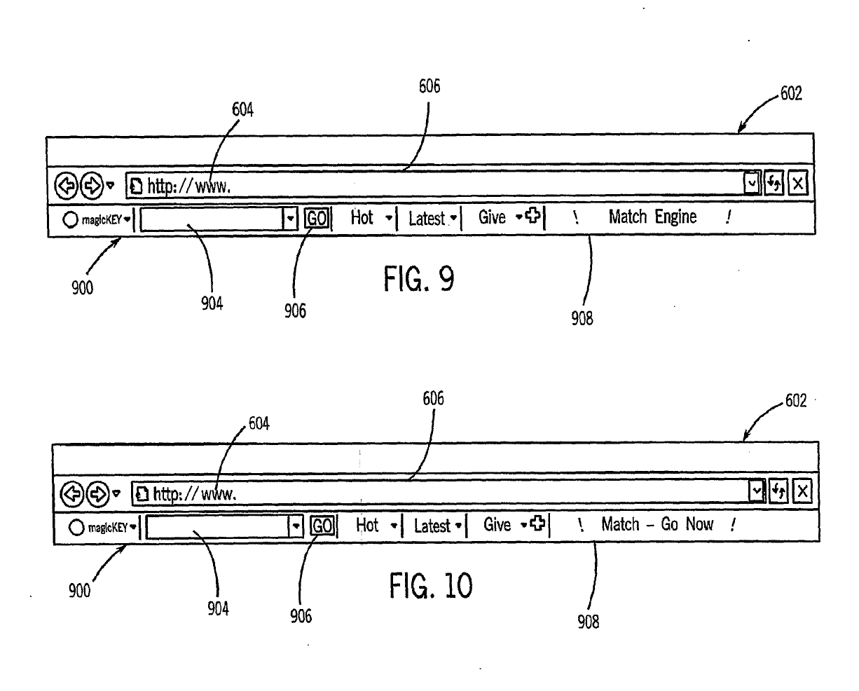

With reference to FIG. 9, a match engine toolbar 900 is provided, for example, as part of browser application 602. Match engine toolbar 900 notifies a user of a match between the current information being viewed using browser application 602 and information that is available from information directory tree 102. One or more keyword may be determined based on what the user is viewing. A match between the determined keyword(s) and a plurality of possible data sources may be performed. For example, the determined keyword(s) are compared with information directory tree 102 to identify information that may be of interest to the user based on the content of the web page being viewed. A match indicator is presented to the user to indicate that a match has been identified. The user may select the matched results for viewing.

Match engine toolbar 900 may include a third search text box 904, a third search button 906, and a match indicator 908. Third search text box 904 and third search button 906 are used in a similar manner as described with reference to second search button 608 and second search text box 610 of FIG. 6. In the exemplary embodiment of FIG. 10, match indicator 908 of FIG. 9 is changed to indicate a match. For example, the text associated with match indicator 908 may change color, may flash, may change content, etc. In the exemplary embodiment of FIG. 10, the text associated with match indicator 908 is changed from “Match Engine” to “Match—Go Now” to indicate a match has been identified. To view the matches, the user selects match indicator 908 which triggers presentation of the information in a user interface such as first search result user interface 700 shown with reference to FIG. 7.

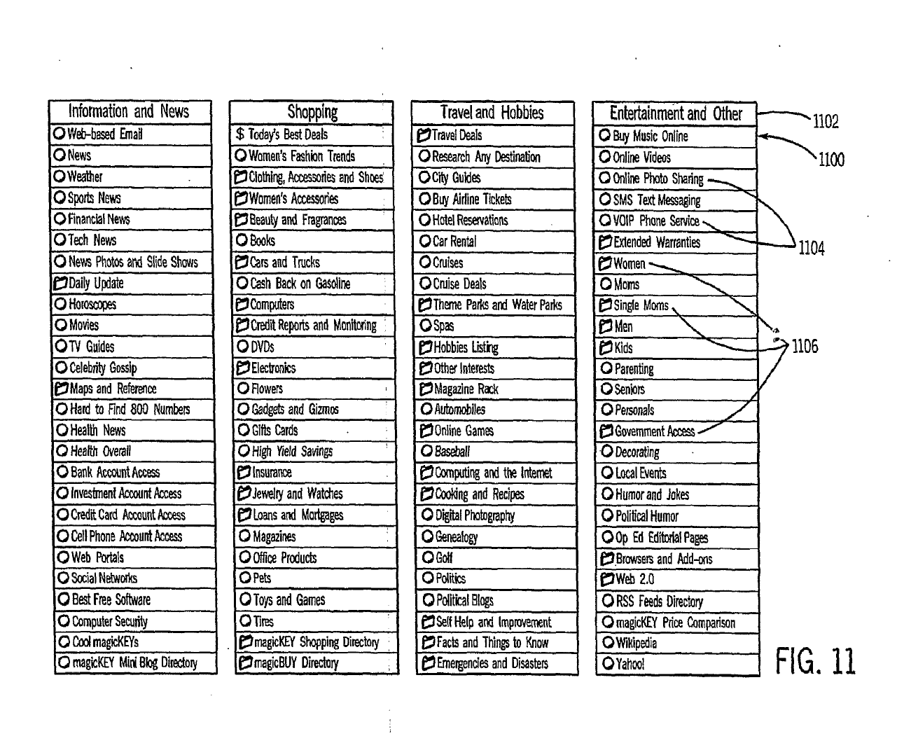

With reference to FIG. 11, a fourth user interface 1100 is shown in accordance with an exemplary embodiment. Fourth user interface 1100 provides direct links to selected guide links and/or folder links. In general, the direct links are to the most popular items in information directory tree 102. By providing the direct links in a single user interface, the user can quickly identify information of interest. Fourth user interface 1100 may include one or more headers 1102 which describe a topic. Presented below each of the one or more headers 1102 are one or more guide links 1104 and/or one or more folder links 1106.

With reference to FIG. 12, a fifth user interface 1200 is shown in accordance with an exemplary embodiment. Fifth user interface 1200 provides product purchasing information associated with a guide link. Using fifth user interface 1200, a user can select and can purchase products, such as cell phones, cameras, TVs, etc. The products included may change based on item popularity and current trends. Fifth user interface 1200 includes directory path 112 for the type of product, a product category list 1202, and one or more product categories 1204. Each of the one or more product categories may include one or more product. Each product may include a product picture 1206, a product name 1207, a product description 1208, one or more links to reviews 1209, one or more links to merchants at which the product can be purchased 1210, a price comparison button 1212, etc. Using fifth user interface 1200, a user can view the products, conduct research, and purchase the product, all using a single user interface. Selection of purchase tab 106, purchase button 410, and/or Purchase button 614 may cause presentation of fifth user interface 1200 to the user for a particular product type.

With reference to FIG. 13, a sixth user interface 1300 is shown in accordance with an exemplary embodiment. Sixth user interface 1300 provides a price comparison information associated with a guide link. For example, a third party price comparison system may be integrated through sixth user interface 1300. Sixth user interface 1300 may include a product type selector menu 1302, a directory path 1304 to the product type comparison, a filter window 1306, and a plurality of products 1308. Selection of price compare tab 108 and/or Price Comparison button 616 may cause presentation of sixth user interface 1300 to the user for a particular product type.

With reference to FIG. 14, a seventh user interface 1400 is shown in accordance with an exemplary embodiment. Seventh user interface 1400 presents one or more deals to a user. Deals include any special offer such as a coupon, a discount, a rebate, a free shipping offer, a cash back offer, notice of a sale, etc. Each deal of seventh user interface 1400 may include a deal description 1402, a deal type 1404, and a “Buy” button 1406 that allows a user to purchase the deal. Deals can be categorized, for example by price points, merchant, item category, special features, etc. Deals may be assigned keywords. Deals can be categorized for grouping and sorting and for searching by users. Deals can also be displayed with search results. Selection of deals tab 110 may cause presentation of seventh user interface 1400 to the user.

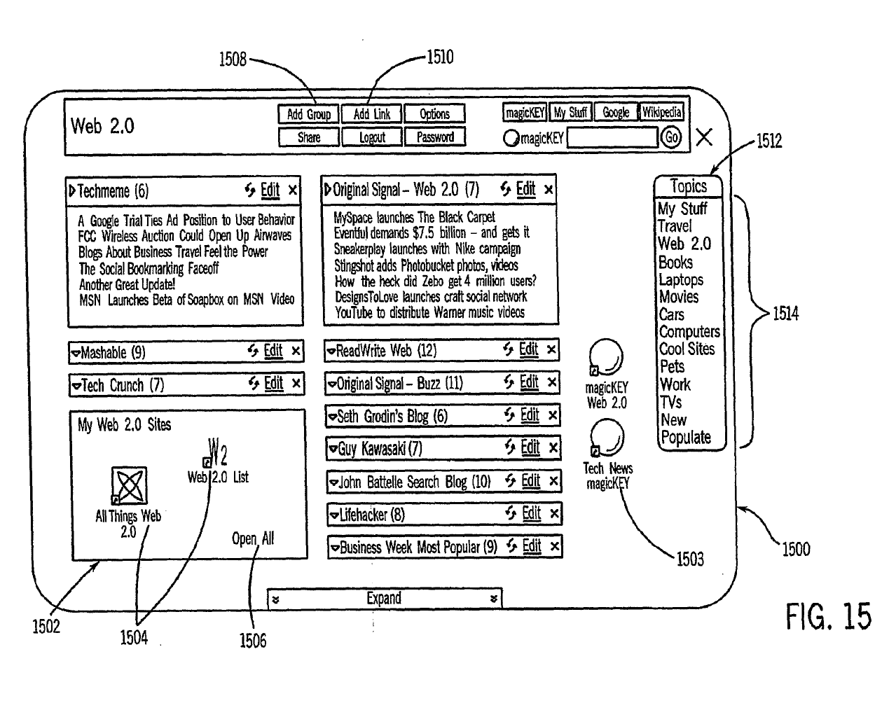

With reference to FIG. 15, an eighth user interface 1500 is shown in accordance with an exemplary embodiment. Eighth user interface 1500 presents information related to favorite informational content identified by a user. The favorite informational content may include links to sites, RSS feeds, widgets, multimedia content, panels, groups, or any other components as known to those skilled in the art. Eighth user interface 1500 may be presented within browser application 602 or may be presented in an independent window. Eighth user interface 1500 may include one or more groups 1502 and one or more ungrouped favorites links 1503. Each group of the one or more groups 1502 may include one or more favorites links 1504 and an “Open All” button 1506. The one or more favorites links 1504 may be links to web pages. Open All button 1506 opens all of the web pages associated with an associated group.

Eighth user interface 1500 further may include an “Add Group” button 1508 and an “Add Link” button 1510. Add Group button 1508 allows a user to create a group to add to the one or more groups 1502 of eighth user interface 1500. Selection of the Add Group button 1508 causes presentation of a dialog box in which a name for the group is requested from the user. Add Link button 1510 allows a user to add a favorites link to the one or more favorites links 1504 of a group or to the one or more ungrouped favorites links 1503. Selection of the Add Link button 1510 causes presentation of a dialog box which requests link information including a link name, a URL, and an icon selection from a user. Links may be dragged from address window 606 of browser application 602 to add the link to a group of the one or more groups 1502 or to the one or more ungrouped favorites links 1503. Eighth user interface 1500 may further include a topics window 1512 which includes a list of topics 1514 that may be selected by the user. The list of topics 1514 allow the user to further organize the information presented in eighth user interface 1500.

Data associated with the one or more groups 1502 may be stored at the user's computer or at a computer accessible by the user's computer using a network. The user can access eighth user interface 1500, for example, by selecting a button from within browser application 102. The user's chosen default panel appears. The user may control the look and arrangement of eighth user interface 1500. In an exemplary embodiment, eighth user interface 1500 is transparent so that the user continues to see the web page displayed using browser application 602 or any other background window. Eighth user interface 1500 may allow a user to right click on an input device such as a mouse to display a variety of options such as New, Edit, Cut, Copy, etc. The user can drag and drop the groups and links within eighth user interface 1500. After creating a new group, the user can drag and drop or paste links into the group.

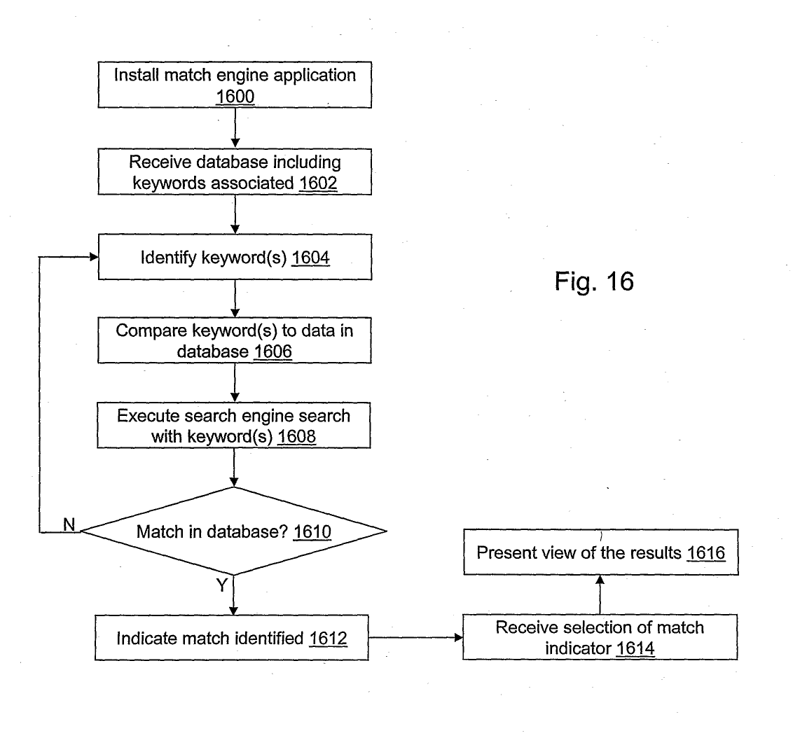

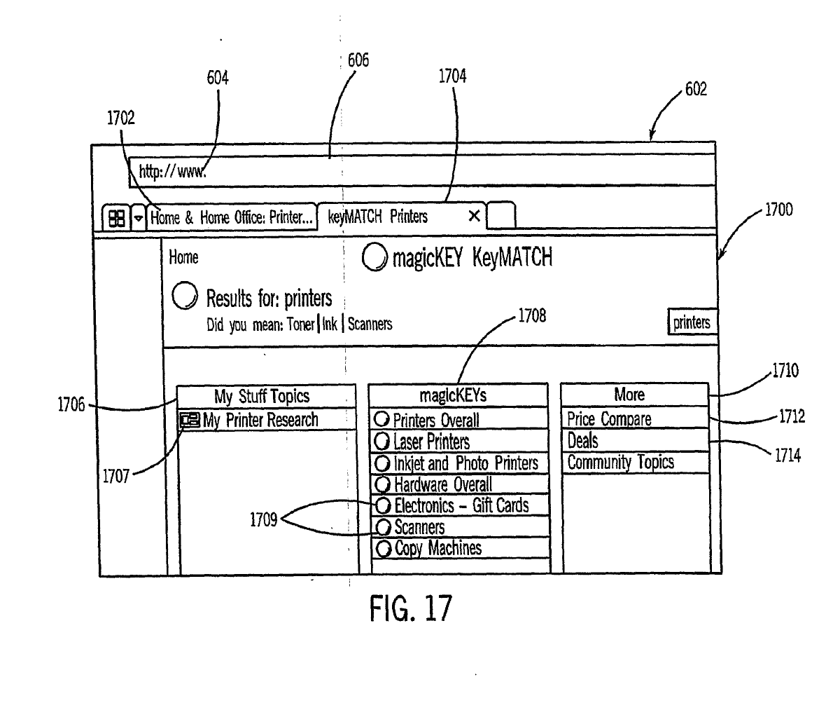

With reference to FIG. 17, a ninth user interface 1700 is shown in accordance with an exemplary embodiment. Ninth user interface 1700 displays matched results identified using the process described with reference to FIG. 16. In the exemplary embodiment of FIG. 17, browser application 602 is a tabbed browser application. For example, a user surfs from web page to web page in a first tab 1702 for printers while a second tab 1704 remains active and is continuously updated whether the user views the user interface associated with second tab 1704 or not. The content of the page the user is viewing, in this case printers, is identified. The keyword “printer” is matched, for example, against the guide links of information directory tree 102. A match is indicated in second tab 1704, for example, by changing the text in the tab header or by changing the color of the tab or of the text in the tab header. The user selects the second tab, and the search results are displayed, for example, as shown with reference to FIG. 17.

A first exemplary presentation of results associated with information directory tree 102 and one or more favorites links 1504 is shown with reference to the exemplary embodiment of FIG. 17. Ninth user interface 1700 may include a favorites list header 1706, a guide links header 1708, and an additional information header 1710. Favorites list header 1706 includes a favorite link 1707. Favorite link 1707 may be a topic in the list of topics 1514 of eighth user interface 1500. Selection by the user of favorite link 1707 may cause presentation, for example, of eighth user interface 1500. Guide links header 1708 includes one or more guide links 1709 selected from the guide links of information directory tree 102 that match the selected keyword(s). The additional information header 1710 includes a “Price Compare” link 1712 and a “Deals” link 1714. Selection by a user of a guide link of the one or more guide links 1709 may cause presentation of a guide link user interface including information associated with the keyword(s). Selection by a user of Price Compare link 1712 may cause presentation of sixth user interface 1300 including information associated with the keyword(s). Selection by a user of Deals link 1714 may cause presentation of seventh user interface 1400 including information associated with the keyword(s).

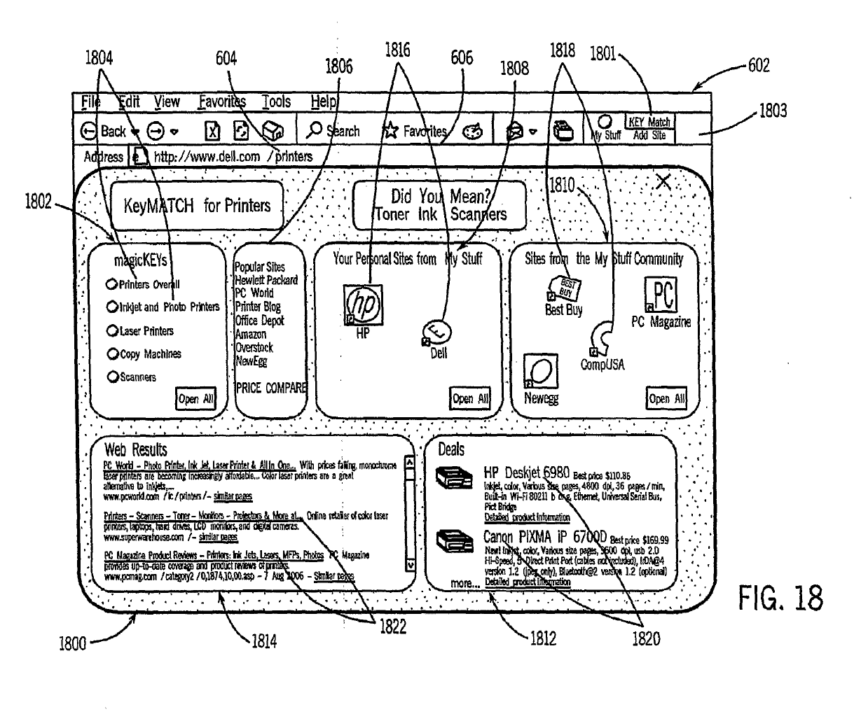

With reference to FIG. 18, a tenth user interface 1800 is shown in accordance with an exemplary embodiment. Tenth user interface 1800 displays matched results identified as the user navigates from web page to web page or entered in a search text box. In the exemplary embodiment shown with reference to FIG. 18, a control button 1801 is included in a browser navigation bar 1803. As the user navigates through various web pages, for example using the Internet, the content of the web page the user is viewing is read and the content is evaluated to identify keyword(s). For example, the keyword “printer” may be identified when a user is viewing printers on a web page. The keyword “printer” is matched, for example, against the guide links of information directory tree 102. A match is indicated in control button 1801, for example, by changing the text in the button or by changing the color of the button or of the text in the button. The user selects control button 1801, and the search results are displayed in tenth user interface 1800. In the exemplary embodiment of FIG. 18, a panel appears over the web page being viewed by the user. The panel displays the matched results.

A second exemplary presentation of results associated with matched results identified using the keyword(s) and information directory tree 102, one or more favorites links 1504, one or more price comparison links, one or more community favorites links, one or more deals, and a search engine is shown with reference to the exemplary embodiment of FIG. 18. Tenth user interface 1800 may include a guide links group 1802, a price comparison group 1806, a favorites group 1808, a community favorites group 1810, a deals link group 1812, and a search engine search results group 1814. Guide links group 1802 includes one or more guide links 1804 selected from the guide links of information directory tree 102 that match the identified keyword(s). Price comparison group 1806 includes one or more links to price comparison information for the products that match the identified keyword(s). Favorites group 1808 includes one or more favorites links 1816 selected from the one or more favorites links 1504 that match the identified keyword(s). Community favorites group 1810 includes one or more community favorites links 1818 that match the identified keyword(s). Deals link group 1812 includes one or more deals links 1820 to deals selected for the products that match the identified keyword(s). Search engine search results group 1814 includes one or more search result links 1822 to search results identified by a search engine using the identified keyword(s).

A guide link development application is provided as an exemplary method of maintaining the content of information directory tree 102 and the guide links. The guide link development application executes on a computer and connects to a database, for example using web technology, to support remote development of the content. The guide link development application is a multi-user system that provides for the management of user accounts, including adding, deleting and changing user accounts, their information and passwords, and access authorities. Only supervisor level personnel can maintain user accounts. A basic user can only maintain content within their own private work area. A supervisor can maintain data in the private work areas and also the public work area.

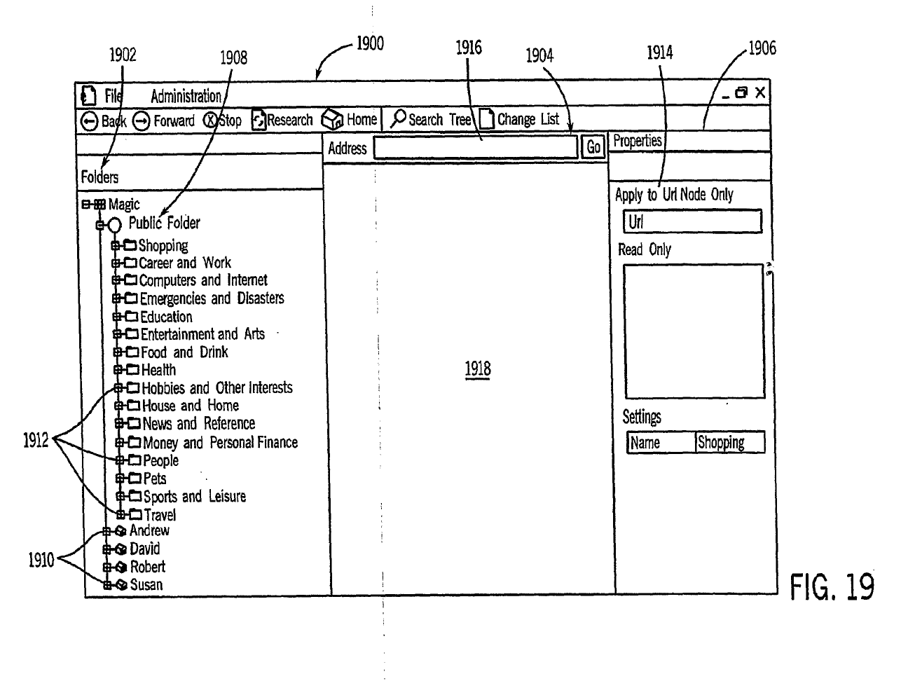

With reference to FIG. 19, an eleventh user interface 1900 is shown in accordance with an exemplary embodiment of the guide link development application. In the exemplary embodiment of FIG. 19, eleventh user interface 1900 is divided into three main work areas: a first work area 1902, a second work area 1904, and a third work area 1906. The work areas can be resized and repositioned based on individual user preference.

First work area 1902 includes a plurality of nodes that describe the structure of information directory tree 102 and the guide links. First work area 1902 may include a root folder 1908, a plurality of topic folders 1912, and a plurality of user's work areas 1910. Second work area 1904 includes an integrated browser application, which allows users to browse sites and manage the content at the same time. Third work area 1906 includes properties of selected items. A properties area 1914 displays relevant information about the given node that a user has selected. Certain useful information is displayed in a read only format, while other information can be updated by the user, such as a node's name and URL.

First work area 1902 provides a combination of drag-and-drop features and context sensitive right-click menus on the nodes. Using these drag-and-drop features in combination with the integrated web browser and the properties area, guide link developers can quickly manage the content, including functions such as: add, change, and delete folders, guide links, and informational links. Informational links can be added by manually entering their description and URL, but may also be dragged into the appropriate node. The guide link developer may drag an informational link from a URL bar 1916 in the integrated web browser, from a link on a page within the integrated web browser viewing area 1918, from the URL bar in a third-party browser running in a session on the user's machine, or from a link on a page in a third-party browser running in a session on the user's machine. When a link is dragged in, the link's URL and description are automatically captured, but may be edited by the guide link developer. A node and its underlying structure may be moved or copied to a different node.

To create a guide link, the style of guide link is determined. In an exemplary embodiment, there are three main styles of guide links—non-shop, simple shop, and advanced shop. Non-shop is for basic informational only subjects. Simple shop is for more basic items that can be purchased. Advanced shop is for more complex (and generally more expensive) items that can be purchased and warrant more detailed research capability from within the guide link.

For each style, there is a template of sub-folders. A blank template can be used as the basis for populating a guide link. The templates include the appropriate sub-folders for each style of guide link. The sub-folders are associated with subject links and subject link drop down selectors and are populated with information links. The information links are “deep links” to the relevant page whenever possible. The templates provide a broad range of possible sub-folders for the particular style of guide link. Some sub-folders may be considered to be required for certain styles while the non-required sub-folders can be used as needed or deleted.

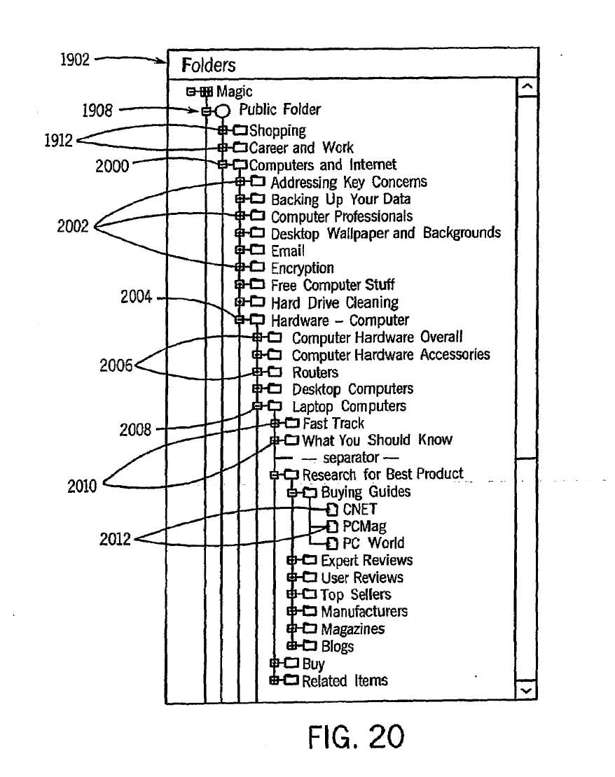

With reference to FIG. 20, additional structural details related to first work area 1902 are provided in accordance with an exemplary embodiment. Selection of a topic folder node 2002 from the plurality of topic folders 1912 results in a display of a plurality of sub-topic folder nodes 2002 related to topic folder node 2002. Selection of a sub-topic folder node 2004 from the plurality of sub-topic folder nodes 2002 results in a display of a plurality of additional sub-topic folder nodes 2006 related to sub-topic folder node 2004. One or more of the additional sub-topic folder nodes 2006 may include guide link nodes. Selection of a guide link node 2008 results in a display of one or more subject nodes 2010 associated with the selected guide link. The hierarchy of folder nodes, guide link nodes, and subject nodes varies in a similar manner to the hierarchy of columns discussed with reference to FIGS. 1-5. Each folder, guide link, and subject node chain ends in one or more information link nodes 2012.

Automated processes identify errors or inconsistencies in the information directory tree 102 created using guide link development application. For example, bad links may be identified and flagged. A “link checker” application may continuously scan and test the information links in information directory tree 102 to identify bad links and flag such links in a database storing information directory tree 102. As part of the same link-checker application, for sites that are good, keywords may be read from the web sites associated with the informational links. Automated processes associate these gathered keywords to the correct guide links. Other automated processes may create and assign keywords to guide links, such as by using words in a guide link's name, words in a guide link's informational link's names, words from the full hierarchy of folder nodes that a guide link is under, etc. Keywords can also be created and assigned manually to guide links with guide link development application 2314. These keywords are later used in search and matching processes.

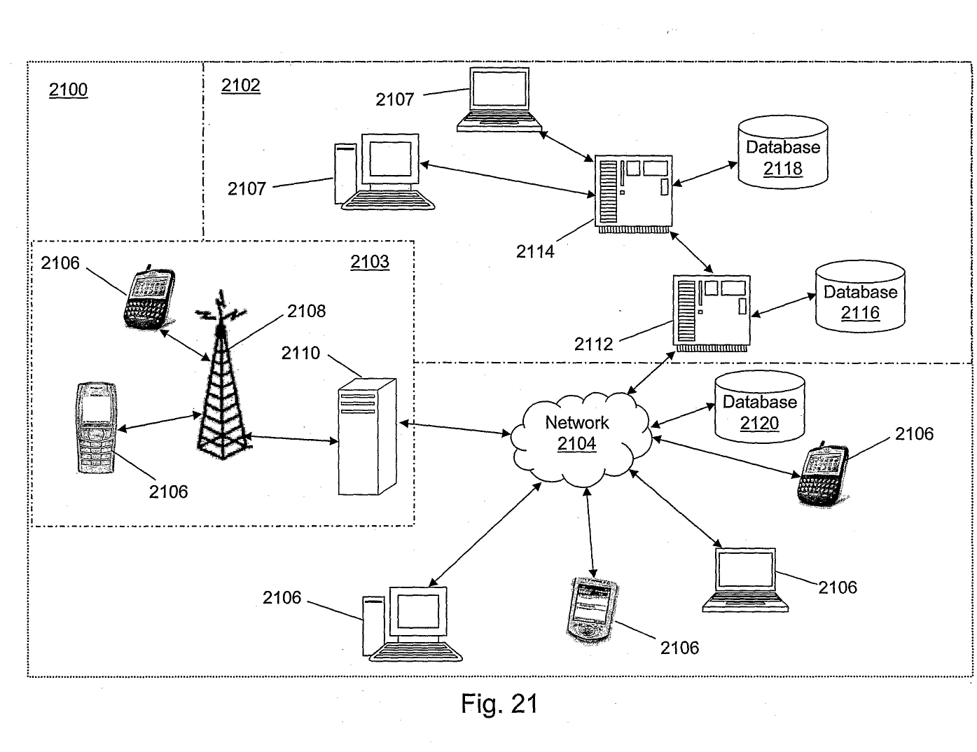

With reference to FIG. 21, a system diagram is shown of a networked system 2100. Networked system 2100 may include a match engine system 2102. Match engine system 2102, which is accessed by users through a network 2104 such as the Internet, may run on a server hosted at a secure hosting facility, which is used to host the live website, for example the website accessed through URL 604, the database accessed by the website, and other components required by the system, such as software that can be downloaded and installed by a user at the user's computing device. For example, a guide link match engine may be downloaded and installed by the user from match engine system 2102. Match engine system 2102 may include a first server 2112 and a second server 2114. External users may access first server 2112 which utilizes a first database 2116. First database 2116 may include the data associated with guide links, the folder hierarchy, deals, etc. First database 2116 may be implemented as a relational database.

Second server 2114 may utilize second database 2118 which stores guide links, the folder hierarchy, deals, etc. for inclusion in first database 2116. Second database 2118 may include guide links, the folder hierarchy, deals, etc. that have not been approved for inclusion in first database 2116. Second database 2118 may be implemented as a relational database. Guide link developers access second server 2114 and second database 2118 using computing devices 2107 to execute a guide link developer application. Exemplary user computing devices 2107 may include computers of any form factor such as a laptop and/or a desktop and may access second server 2114 using a network. Guide link developers utilize the environment of second server 2114 and second database 2118 to develop and test guide links. After acceptance testing, the information may be moved to database 2116 so that the developed guide links are accessible by external users. A third database 2120 may be accessed by computing devices 2107 and/or user computing devices 2106.

Networked system 2100 further may include a cellular network 2103 and a plurality of user computing devices 2106. There may be fewer or additional networks in networked system 2100 as known to those skilled in the art. Cellular network 2103 can include a network server 2110, a base station 2108, and a plurality of user computing devices 2106. For example, cellular network 2103 may include an integrated messaging device, such as a Blackberry device manufactured by Research in Motion, and/or a cellular telephone. Network server 2110 allows communication between the user computing devices 2106 and network 2104. In the cellular network 2103, devices send and receive signals through base station 2108.

Networked system 2100 can include any number and type of computing devices and may be organized into subnets. Any of the subnets or devices may be separated by a firewall. Exemplary user computing devices 2106 may include computers of any form factor such as a laptop, a desktop, an integrated messaging device, a personal digital assistant, etc. Networked system 2100 may include additional types of devices. User computing devices 2106 communicate using various transmission media that may be wired or wireless.

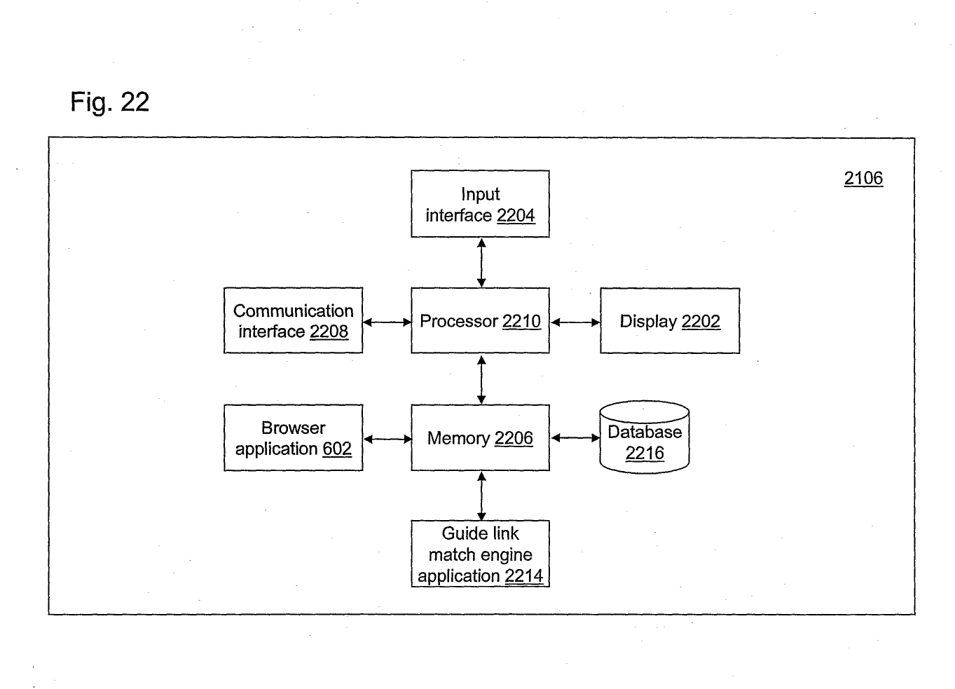

With reference to FIG. 22, a user computing device 2106 is shown in an exemplary embodiment. User computing device 2106 may include a display 2202, an input interface 2204, a communication interface 2208, a memory 2206, a processor 2210, browser application 602, a guide link match engine application 2214, and a database 2216. Different and additional components may be incorporated into computing device 2106. Display 2202 presents information to a user of computing device 2106 as known to those skilled in the art. For example, display 2202 may be a thin film transistor display, a light emitting diode display, a liquid crystal display, or any of a variety of different displays known to those skilled in the art.

Input interface 2204 provides an interface for receiving information from the user for entry into computing device 2106 as known to those skilled in the art. Input interface 2204 may use various input technologies including, but not limited to, a keyboard, a pen and touch screen, a mouse, a track ball, a touch screen, a keypad, one or more buttons, etc. to allow the user to enter information into computing device 2106 or to make selections presented in a user interface displayed on display 2202. Input interface 2204 may provide both an input and an output interface. For example, a touch screen both allows user input and presents output to the user.

Communication interface 2208 provides an interface for receiving and transmitting messages, files, and any other information communicable between devices using various protocols, transmission technologies, and media as known to those skilled in the art.

Memory 2206 is an electronic holding place for information so that the information can be reached quickly by processor 2210. Computing device 2106 may have one or more memories that use the same or a different memory technology. Memory technologies include, but are not limited to, any type of RAM, any type of ROM, any type of flash memory, etc.

Processor 2210 executes instructions as known to those skilled in the art. The instructions may be carried out by a special purpose computer, logic circuits, or hardware circuits. Thus, processor 2210 may be implemented in hardware, firmware, software, or any combination of these methods. The term “execution” is the process of running an application or the carrying out of the operation called for by an instruction. The instructions may be written using one or more programming language, scripting language, assembly language, etc. Processor 2210 executes an instruction, meaning that it performs the operations called for by that instruction. Processor 2210 couples to display 2202, to input interface 2204, and to communication interface 2208 to receive and to process information. Processor 2210 may retrieve a set of instructions from a permanent memory device and copy the instructions in an executable form to a temporary memory device that is generally some form of RAM. Computing device 2106 may include a plurality of processors that use the same or a different processing technology.

Guide link match engine application 2214 performs operations associated with matching keyword(s) to various informational resources. Some or all of the operations and interfaces described with reference to FIGS. 1-18 may be embodied in guide link match engine application 2214. The operations may be implemented using hardware, firmware, software, or any combination of these methods. With reference to the exemplary embodiment of FIG. 22, guide link match engine application 2214 is implemented in software stored in memory 2206 and accessible by processor 2210 for execution of the instructions that embody the operations of guide link match engine application 2214. Guide link match engine application 2214 may be written using one or more programming languages, assembly languages, scripting languages, etc.

Database 2216 may store information for use by guide link match engine application 2214. For example, database 2216 stores information associated with one or more favorites links 1707, 1816, one or more community favorites links 1818, deals links 1820, guide links 1709, 1804, and/or keyword(s) associated therewith. Database 2216 may be organized into multiple databases to improve data management and access. The multiple databases may be organized into tiers. Database 2116 also may store information for use by guide link match engine application 2214.

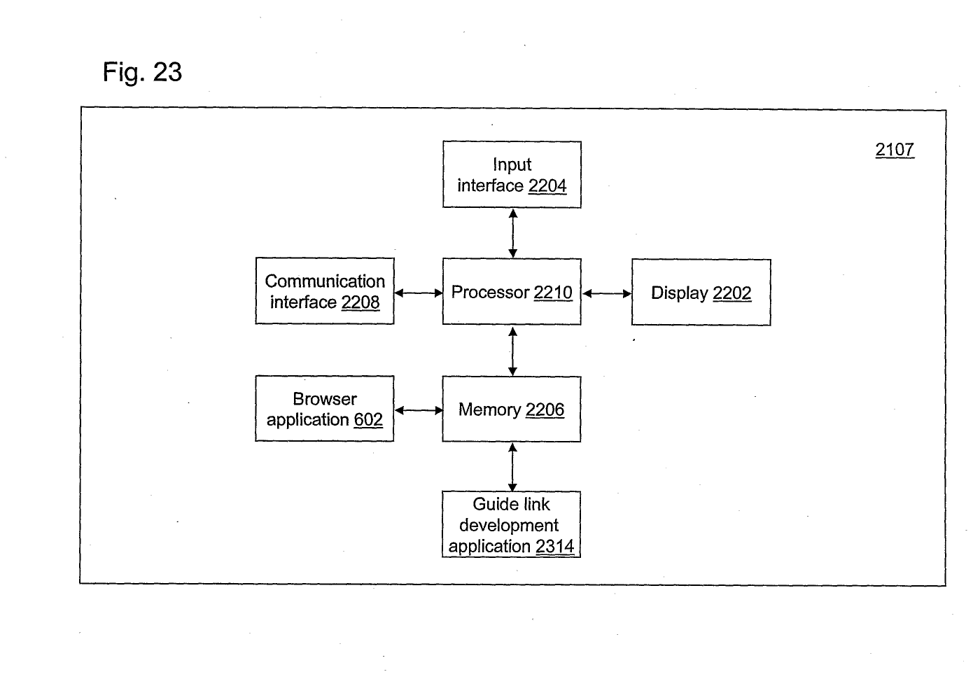

With reference to FIG. 23, a guide link developer's computing device 2107 is shown in an exemplary embodiment. Guide link developer's computing device 2107 may include display 2202, input interface 2204, communication interface 2208, memory 2206, processor 2210, browser application 602, and a guide link development application 2314. Different and additional components may be incorporated into guide link developer's computing device 2107.

Guide link development application 2314 performs operations associated with developing and maintaining information directory tree 102 and the guide links. Some or all of the operations and interfaces described with reference to FIGS. 19-20 may be embodied in guide link development application 2314. The operations may be implemented using hardware, firmware, software, or any combination of these methods. With reference to the exemplary embodiment of FIG. 23, guide link development application 2314 is implemented in software stored in memory 2206 and accessible by processor 2210 for execution of the instructions that embody the operations of guide link development application 2314. Guide link development application 2314 may be written using one or more programming languages, assembly languages, scripting languages, etc.

With reference to FIG. 16, exemplary operations associated with identifying relevant information while a user browses a network are described. Additional, fewer, or different operations may be performed, depending on the embodiment without deviating from the spirit of the invention. In an operation 1600, a match engine application is installed at a user's computing device. In an exemplary embodiment, the match engine application is installed as a toolbar in browser application 602, for example as shown with reference to FIGS. 9 and 10. In an alternative embodiment, the match engine application is accessible in a second tab in a tabbed browser, for example as shown with reference to FIG. 17. In another alternative embodiment, the match engine application is accessible using a control button added to a tool bar of browser application 602, for example as shown with reference to FIG. 18.

In an operation 1602, a database may be received from a server computer using a network. A database is a software component. For example, database 2216 is received which contains one or more favorites links 1707, 1816, one or more community favorites links 1818, deals links 1820, guide links 1709, 1804, and/or keyword(s) associated therewith. The database may be updated periodically, for example, when changes are detected between database 2216 and database 2116, when database 2216 changes, etc. The database may be pulled from a network computer by the user's computer or pushed to the user's computer by a network computer as known to those skilled in the art.

In an operation 1604, a keyword is identified. For example, the keyword may be identified from the URL of the web page the user is currently viewing, from a search term the user entered in a search text box, from a topic identified from information associated with the web page the user is currently viewing, from an item identified from the web page the user is currently viewing, from the favorites links identified by the user, from community favorites links, etc. The keyword may be determined from what a user is looking at in a web browser using various techniques and combinations of techniques. For example, a process can be developed specifically for each of a plurality of highly popular sites to accurately identify the specific contents of a page. As another example, the page content can be analyzed using techniques such as, but not limited to, metatag analysis, common keywords and page text analysis, header analysis, regular expression techniques, etc. As yet another example, the site's URL in the address bar can be analyzed including the core website name itself and other parts of the page address that can indicate a page's content. As yet another example, website translation table can be used. For example, if user is on “carnival.com”, which is determined from the URL, the translation table can relate carnival.com to the topic of “cruises”. Such a translation table can be included in database 2216 and/or database 2116. If multiple keywords are determined, a user can be presented with a list of the keywords and be prompted to pick the best result.

The processing used to identify the keyword can be run locally, on a central server, or any combination. Any data and components in eighth user interface 1500, including links to sites, RSS feeds, widgets, multimedia content, panels, groups, or any other components may have both keywords and titles attached to them. Such data may reside in database 2216 and/or database 2116. Keywords can be assigned by users, i.e. users can tag any component with any keyword of their choice. The titles of any component can be modified by users. Eighth user interface 1500 also may provide a populate feature in which a user, through a variety of methods, can request that their data be populated with recommended content and components about a topic. For example, if the user requests populated data about weather, the system can populate a weather topic with components such as links to weather sites, a weather widget, links to weather RSS feeds, etc. All such populated components may also include titles and keywords already attached. The user can modify and maintain the populated components, including the keywords and titles.

To determine a keyword from what a user is looking at in eighth user interface 1500, for example, the titles and keywords attached to the components on the currently viewed panel can be analyzed. In addition, to determine a keyword from what a user is looking at in eighth user interface 1500, the links on the panel can be analyzed using various techniques as discussed above.

In an operation 1606, the identified keyword is compared to entries in the received database. For example, database 2216 and/or first database 2116 may include a summary table of keywords associated with guide links, favorites links, community favorites links, deals links, etc. In an exemplary embodiment, the identified keyword is compared to keywords associated with a plurality of data resource types. For example, guide links, favorites links, community favorites links, and deals links represent different data resource types.

In an operation 1608, the identified keyword is used to execute a search using a search engine accessible using a network such as the Internet. Exemplary search engines include Internet search engines available from companies such as Google®, Yahoo®, MSN®, etc. In general, search engines identify a match with the identified keyword. Additional data resource types, such as price comparisons, forums, etc. may have pre-established search processes that accept the identified keyword as input and output results in a variety of formats that can be processed to determine if a match occurred, what type of match occurred, and include the resulting matching data. For example, this type of match may occur over a network to third database 2120.

The matching process can also be performed to various levels of detail and return various levels of results depending on how much initial data is to be displayed. For example, it may be sufficient to recognize that a single match of any type exists if the user is only being notified of a match with a single button display. If initial matching results are being displayed, such as in FIG. 17, then it may be necessary to perform a more detailed search and return actual results.

In an operation 1610, a determination is made concerning whether or not the identified keyword matches an entry in the database. If a match of the keyword to an entry in the database is not found, processing continues at operation 1604. If a match of the keyword to an entry in the database is found, processing continues at an operation 1612. In operation 1612, a match indicator indicates a match to the user. A match indicator may include the toolbar, second tab, and/or control button of browser application 602, a pop-up message box, a side bar of browser application 602, a sound emitted by a speaker, etc. For example, text and/or color may change to indicate a match. Additionally, the match indicator may include initial data associated with the match. In an exemplary embodiment wherein a plurality of data resource types are compared, the match indicator may include a separate indicator for each of the plurality of data resource types. Exemplary data resource types include favorites links, community favorites links, price comparison links, and deals links. In another alternative embodiment, the user may request a determination of whether or not a match is identified.

In an operation 1614, selection of the match indicator is received. For example, the user may select the toolbar, second tab, and/or control button of browser application 602. The selection is received. In an operation 1616, a view of the identified match results is presented to the user. For example, results similar to those shown in the user interfaces of FIGS. 7, 17, and 18 may be presented to the user. Additionally, results associated with the plurality of data resource types may be accessed using separate tabs in a tabbed browser.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A device comprising:
a processor, the processor configured to
identify a keyword from an application user interface, wherein the identification is performed transparent to a user viewing the application user interface;
compare the identified keyword with information associated with a plurality of guide links, wherein a guide link is associated with a categorized collection of information about a topic;
identify a relevant guide link of the plurality of guide links that matches the identified keyword based on the comparison;
if a relevant guide link is identified, indicate a match between the identified keyword and the identified guide link; and
if a relevant guide link is identified, allow a user to view the identified guide link.

2. A computer-readable medium having computer-readable instructions stored thereon that, upon execution by a processor, cause the processor to identify relevant information while a user views an application user interface, the instructions comprising:
identifying a keyword from an application user interface, wherein the identification is performed transparent to a user viewing the application user interface;
comparing the identified keyword with a plurality of guide links, wherein a guide link is associated with a categorized collection of information about a topic;
identifying a relevant guide link of the plurality of guide links that matches the identified keyword based on the comparison;
if a relevant guide link is identified, indicating a match between the identified keyword and the identified guide link; and
if a relevant guide link is identified, allowing a user to view the identified guide link.

3. A method of identifying relevant information while a user views an application user interface, the method comprising:
identifying a keyword from an application user interface presented at a first computer, wherein the identification is performed transparent to a user viewing the application user interface;
comparing the identified keyword with information associated with a plurality of guide links, wherein a guide link is associated with a categorized collection of information about a topic;
identifying a relevant guide link of the plurality of guide links based on the comparison;
if a relevant guide link is identified, indicating a match between the identified keyword and the identified relevant guide link at the first computer; and
if a relevant guide link is identified, allowing a user to view the identified relevant guide link at the first computer.

4. The method of claim 3, wherein the application user interface displays a web page.

5. The method of claim 4, wherein the keyword is identified from a URL of the web page.

6. The method of claim 3, wherein the keyword is identified from a topic identified for the application user interface.

7. The method of claim 3, wherein the plurality of guide links are stored in a database.

8. The method of claim 7, wherein the database includes a second data resource type.

9. The method of claim 8, wherein the second data resource type is selected from the group consisting of favorite informational content, community favorite informational content, price comparison information, product purchasing information and deals links.

10. The method of claim 8, further comprising:
comparing the identified keyword with the second data resource type;
identifying a data resource of the second data resource type that matches the identified keyword based on the comparison;
if a data resource is identified, indicating a second match between the identified keyword and the identified data resource at the first computer; and
if a data resource is identified, allowing a user to view the identified data resource at the first computer.

11. The method of claim 10, wherein the match is indicated separately for the identified guide link and the identified data resource.

12. The method of claim 3, further comprising executing a search engine using the identified keyword, the search engine executing at a second computer accessible using a network.

13. The method of claim 3, wherein the match is indicated using a match indicator presented in the application user interface.

14. The method of claim 13, wherein the text of the match indicator is changed to indicate a match.

15. The method of claim 13, wherein the color of the match indicator is changed to indicate a match.

16. The method of claim 3, wherein the match is indicated by playing a sound at the first computer.

17. The method of claim 13, wherein the match indicator is a pop-up message box.

18. The method of claim 13, wherein the match indicator is a control button.

19. The method of claim 13, wherein the match indicator is a sidebar.

20. The method of claim 13, wherein the match indicator is a tab of a tabbed browser application.

21. The method of claim 3, further comprising receiving a database at the first computer from a second computer using a network, the database including a plurality of keywords associated with the plurality of guide links.

22. The method of claim 21, further comprising storing the database at the first computer.

23. The method of claim 22, further comprising receiving an update of the database at the first computer from the second computer using the network.

24. The method of claim 21, wherein the comparison is performed at the first computer.

25. The method of claim 3, further comprising sending the identified keyword to a second computer using a network.

26. The method of claim 25, wherein the comparison is performed at the second computer.

27. The method of claim 26, wherein the relevant guide link is identified at the second computer.

28. The method of claim 27, wherein the identified relevant guide link is sent to the first computer using the network.

29. A method of identifying relevant favorite informational content while a user views an application user interface, the method comprising:
identifying a keyword from an application user interface presented at a first computer, wherein the identification is performed transparent to a user viewing the application user interface;
comparing the identified keyword with information associated with favorite informational content selected by the user;
identifying relevant informational content of the favorite informational content based on the comparison;
if relevant informational content is identified, indicating a match between the identified keyword and the identified relevant informational content at the first computer; and
if relevant informational content is identified, allowing a user to view the identified relevant informational content at the first computer.

30. A method of identifying relevant product purchasing information while a user views an application user interface, the method comprising:
identifying a keyword from an application user interface presented at a first computer, wherein the identification is performed transparent to a user viewing the application user interface;
comparing the identified keyword with product purchasing information;
identifying a relevant product from the product purchasing information based on the comparison;
if a relevant product is identified, indicating a match between the identified keyword and the identified relevant product at the first computer; and
if a relevant product content is identified, allowing a user to view the identified relevant product at the first computer.
